(19) United States
(12) Patent Application Publication
(10) Pub. No.: US 2013/0304877 A1
(43) Pub. Date: Nov. 14, 2013

(54) SYSTEM AND METHOD FOR DYNAMIC CONFIGURATION OF ISN STORE-BASED OVERLAY NETWORK

(71) Applicants: Tai-Won Um, Seoul (KR); Chang-Woo Yoon, Daejeon-si (KR); Kang-Woon Hong, Seoul (KR); Ho-Yeon Lee, Goyang-si Gyeonggi-do (KR); Hyun-Woo Lee, Daejeon-si (KR); Won Ryu, Daejeon-si (KR)

(72) Inventors: Tai-Won Um, Seoul (KR); Chang-Woo Yoon, Daejeon-si (KR); Kang-Woon Hong, Seoul (KR); Ho-Yeon Lee, Goyang-si Gyeonggi-do (KR); Hyun-Woo Lee, Daejeon-si (KR); Won Ryu, Daejeon-si (KR)

(21) Appl. No.: 13/696,016

(22) PCT Filed: Nov. 7, 2011
(86) PCT No.: PCT/KR2011/008410

§ 371 Date: Nov. 2, 2012

(30) Foreign Application Priority Data
Nov. 8, 2010 (KR) 10-2010-0110460

(51) Int. Cl. H04L 12/24

(52) U.S. Cl. CPC H04L 41/0823
USPC 709/220

(57) ABSTRACT

A system for dynamically configuring an overlay network using an intelligent service networking (ISN) store is provided. The system includes an ISN store configured to register and manage information on network OT resources for providing an overlay network-based service available in a network; a DCON device configured to receive network OT resource information necessary for a service provider to provide the overlay network-based service from the ISN store upon the requests of the service provider and a service user and to dynamically configure an overlay network for providing the overlay network-based service based on the received network OT resource information; and a network OT resource provider configured to register the network OT resources in the ISN store.

### TECHNICAL FIELD

The present invention relates to an overlay network technique.

### BACKGROUND ART

An overlay network is a virtual network built on top of a physical network having existing network functions, and has a virtual service routing function. That is, an overlay network is a virtual network built on top of another network by using nodes and logical links. Since adjacent nodes in an overlay network are not physically but logically adjacent to one another, an overlay network can provide efficient network services by maximizing the use of an existing network. Various methods have been suggested to improve the service performance and efficiency of a network and diversify functions of a network through an overlay network reconfigured on a logical/physical network.

In the meantime, in accordance with the ever-increasing user demand for the openness, stability, and variety of services, research has been conducted on various next-generation service overlay networks, such as Next Generation Service Overlay Network (NGSON), Ambient Network (AN), or AKARI. Next-generation service overlay networking is a service request-based dynamic, adaptive overlay networking technique capable of providing most suitable services with desirable quality to users effectively network-wise through an automatic reconfiguration of an overlay network. Next-generation overlay networks can provide various functions, such as adaptively changing networking parameters according to dynamic flow information in physical networks and according to circumstance information of physical networks, which affects routing decisions.

### TECHNICAL PROBLEM

A system for efficiently providing a service with a quality desired by a user upon the request of the user through a dynamic, adaptive, automatic reconfiguration of a network is needed.

### TECHNICAL SOLUTION

The present invention provides an intelligent service network (ISN) store, which registers and manages network resources (such as networking, processing, and storage resources) held by individuals or internet service providers (ISPs) so that the network resources can be shared, and an operating method of the ISN store.

The present invention also provides a dynamic-configuration-of-overlay-network (DCON) device, which dynamically configures an overlay network based on network resources registered in an ISN store, and an operating method of the DCON device.

### BEST MODE

The present invention provides an apparatus for dynamically configuring an overlay network, the apparatus including a service information registration unit configured to register service information of a service provider, which provides an overlay network-based service; an overlay transport (OT) search/registration unit configured to issue a request for network OT resource information necessary for the service provider to provide the overlay network-based service to an intelligent service network (ISN) store based on the service information, to acquire the network OT resource information from the ISN store, and to register the acquired network OT resource information; and a service network topology configuration unit configured to dynamically configure an overlay network for providing the overlay network-based service between the service provider and a service user of the overlay network-based service based on the acquired network OT resource information and to provide information on the configured overlay network to the service provider, the service user, and a network OT resource provider of network OT resources included in the configured overlay network.

The present invention also provides an ISN store including an OT registration unit configured to receive network OT resource information for providing an overlay network-based service from a network OT resource provider and register the network OT resource information; an OT information DB configured to store the registered network OT resource information; an OT monitoring unit configured to monitor state information of network OT resources corresponding to the registered network OT resource information; and an OT search unit configured to receive a request for network OT resource information, which is issued in connection with a service request received by a service provider, from a DCON device, to search through the registered network OT resource information and the state information of the network resources corresponding to the registered network OT resource information, and to provide the results of the searching to the DCON device.

The present invention also provides a method of dynamically configuring an overlay network, the method including registering service information of a service provider, which provides an overlay network-based service; issuing a request for network OT resource information necessary for the service provider to provide the overlay network-based service to an ISN store based on the service information, and acquiring the network OT resource information from the ISN store; dynamically configuring an overlay network for providing the overlay network-based service between the service provider and a service user of the overlay network-based service based on the acquired network OT resource information; and providing information on the configured overlay network to the service provider, the service user, and a network OT resource provider of network OT resources included in the configured overlay network.

The present invention also provides a system for dynamically configuring an overlay network using an ISN store, the system including an ISN store configured to register and manage information on network OT resources for providing an overlay network-based service available in a network; a DCON device configured to receive network OT resource information necessary for a service provider to provide the overlay network-based service from the ISN store upon the requests of the service provider and a service user and to dynamically configure an overlay network for providing the overlay network-based service based on the received network OT resource information; and a network OT resource provider configured to register the network OT resources in the ISN store.

The present invention also provides a method of dynamically configuring an overlay network, the method including allowing an ISN store to register information on network OT resources for providing an overlay network-based service available in a network; allowing the ISN store to manage state information of the network OT resources; allowing a DCON device to receive a request for the provision of an overlay network from a service provider, which provides an overlay network-based service; allowing the DCON device to analyze the received request and to issue a request for necessary network OT resources to the ISN store; allowing the ISN store to search through the network OT resource information and the network OT resource state information and to provide the results of the searching to the DCON device; allowing the DCON device to dynamically configure an overlay network for the service provider to provide the overlay network-based service based on network OT resource information and network OT resource state information provided by the ISN store; and allowing the DCON device to transmit information on the configured overlay network to the service provider.

Additional features of the invention will be set forth in the description which follows, and in part will be apparent from the description, or may be learned by practice of the invention.

### ADVANTAGEOUS EFFECTS

According to the present invention, individuals or ISPs with neither service nor network resources may provide services such as IPTV services, SNSs and personal broadcasting services, without the aid of network operators, using networking, processing, and storage resources registered in an ISN store by other individuals or ISPs. In addition, network OT resource providers may make profit by registering networking, processing, and storage resources in the ISN store.

In addition, according to the present invention, individuals and ISPs may disclose their networking, processing, and storage resources through the ISN store, and may make profit when their networking, processing, and storage resources are used by other individuals and ISPs, thereby configuring an ecosystem between service providers, service users, and network OT resource providers.

### DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an example of a network environment for dynamically configuring an intelligent service network (ISN)-based overlay network.

FIG. 2 is a diagram illustrating an example of an ISN store shown in FIG. 1.

FIG. 3 is a diagram illustrating an example of a dynamic configuration-of-overlay network (DCON) device shown in FIG. 1.

FIG. 4 is a diagram illustrating examples of interfaces between an ISN store, a DCON device, and a transmission node, a reception node, and core nodes, which are involved in transmission in an overlay network.

FIG. 5 is a diagram illustrating an example of how to transfer network- and user-adaptive overlay multicast services through a dynamic configuration of an ISN-based overlay network using an ISN store and a DCON device.

FIG. 6 is a flowchart illustrating an example of a method of dynamically configuring an overlay network, which is performed by a DCON device.

FIG. 7 is a flowchart illustrating an example of the operation of an ISN store.

### MODE FOR INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

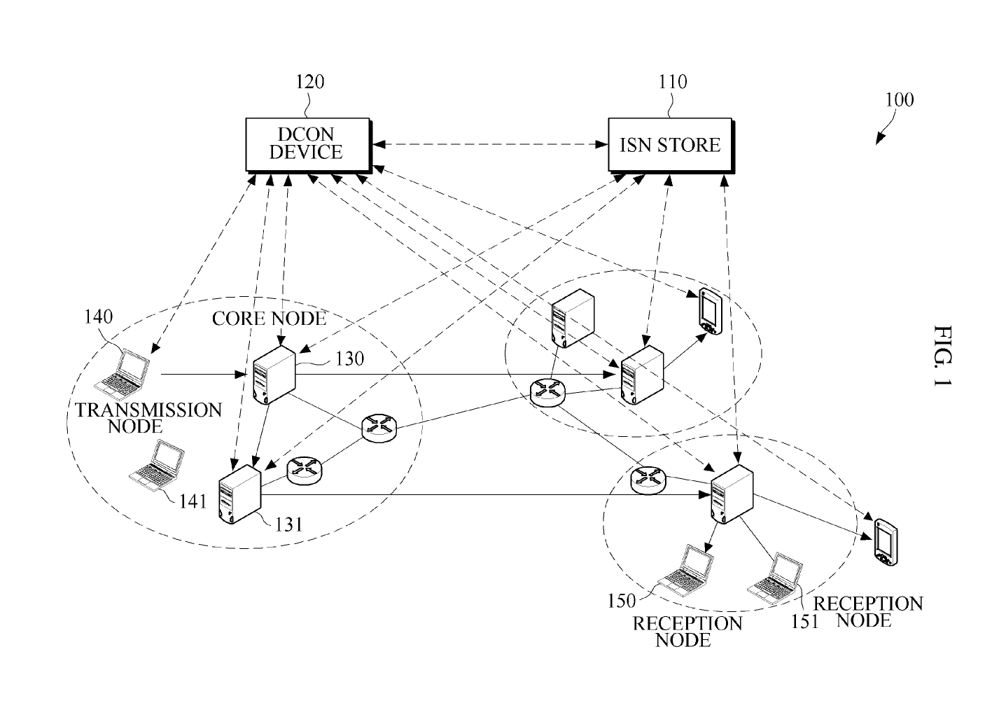

FIG. 1 illustrates an example of a network environment for dynamically configuring an intelligent service networking (ISN)-based overlay network. Referring to FIG. 1, an ISN store-based overlay network system 100 includes an ISN store 110, a dynamic configuration-of-overlay network (DCON) device 120, core nodes 130 and 131, transmission nodes 140 and 141, and reception nodes 150 and 151. The ISN store-based overlay network system 100 dynamically an ISN-based overlay network, and operates to transfer overlay network-based services from the transmission nodes 140 and 141 to the reception nodes 150 and 151 via the configured overlay network. The overlay network-based services include internet protocol (IP) TV services, social networking services (SNSs), personal broadcasting services, data transfer services, data storage services, and data processing services.

The core nodes 130 and 131 correspond to network servers or network transfer systems. The network resources required for providing overlay network-based services will hereinafter be referred to as network overlay transport (OT) resources. The core nodes 130 and 131 may be referred to as network OT resource providers since they provide the network resources required for providing overlay network-based services. The transmission nodes 140 and 141 may correspond to overlay network-based service providers (hereinafter referred to as the service providers), such as individuals or internet service providers (ISPs). The reception nodes 150 and 151 may correspond to user terminals that are provided with overlay network-based services.

Referring to FIG. 1, the ISN store-based overlay network system 100 may include more than one core node, more than one transmission node, and more than one reception node. The core nodes 130 and 131, the transmission nodes 140 and 141, and the reception nodes 150 and 151 may be individuals, ISPs, or network resource providers. The transmission nodes 140 and 141 and the reception nodes 150 and 151 may be user terminals such as personal computers (PCs), laptop computers, or mobile terminals. A single node may be configured to perform at least one of the functions of a core node, a transmission node, and a reception node. The operations of the core node 130, the transmission node 140, and the reception node 150 will hereinafter be described in further detail.

The ISN store 110 is an ISN device that registers and manages network resource information for providing networking, processing, and storage functions for use in the provision of overlay network-based services. The ISN store 110 may be configured to verify and manage real network resources corresponding to the registered network resource information. The ISN store 110 may receive network OT resource information from the core node 130.

The DCON device 120 is an apparatus for dynamically configuring an overlay network, which searches the ISN store 110 for network OT resources having network-related function elements for providing an overlay network-based service, upon the request of an overlay network-based service provider and an overlay network-based service user, and dynamically configures an overlay network based on the identified network OT resources.

The transmission node 140 may register service information for providing an overlay network-based service with the DCON device 120, and the DCON device 120 may manage the service information.

An overlay network corresponds to a path of the transfer of an overlay network-based service between the transmission node 140 and the reception node 150. An overlay network may be configured as a service transfer path including a plurality of core nodes, e.g., the core nodes 130 and 131. The DCON device 120 may dynamically configure an overlay network in consideration of the state of network resources that can be used in the provision of an overlay network-based service and the specification of an overlay network-based service user terminal.

For example, in order to support various overlay services and provide expandability, the ISN store 110, in which network OT resources are registered, may be separate from the DCON device 120, which dynamically configures an overlay network based on the network OT resources registered in the ISN store 110, but the present invention is not limited to this.

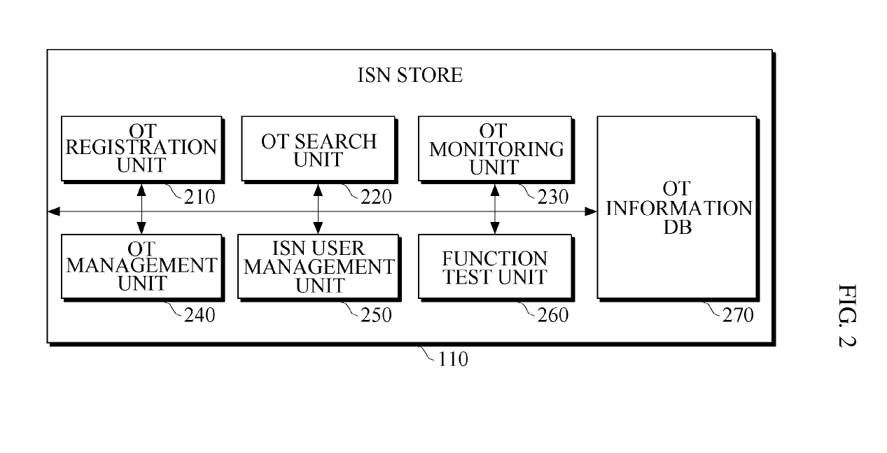

FIG. 2 illustrates an example of the ISN store 110. Referring to FIG. 2, the ISN store 110 may include an OT registration unit 210, an OT search unit 220, an OT monitoring unit 230, an OT management unit 240, an ISN user management unit 250, a function test unit 260, and an OT information database (DB) 270. The OT registration unit 210, the OT search unit 220, the OT monitoring unit 230, the OT management unit 240, the ISN user management unit 250, the function test unit 260, and the OT information DB 270 may be interconnected through an internal network so as to be operable in connection with one another.

The OT registration unit 210 registers network OT resources, such as networking, processing, and storage resources. When a request for the registration of particular network OT resources is received from a network OT resource provider, i.e., the core node 130, the OT registration unit 210 may verify and accept the particular network OT resources. The OT registration unit 210 receives network OT resource information on the particular network OT resources from the core node 130, stores the received network OT resource information in the OT information DB 270, and manages the stored network OT resource information, thereby registering the particular network OT resources. Network OT resource information may include the name, type, universal resource locator (URL) address, and location (i.e., geographical address and latitude/longitude information) of network OT resources and operation information on operations provided by network OT resources.

The OT search unit 220 searches for network OT resource information registered in the OT information DB 270. The OT search unit 220 may search through the network OT resource information in the OT information DB 307 on the basis of categories, names, providers, locations, and states. A list of network OT resources searched for by the OT search unit 220 and their respective network OT resource information may be displayed as a graphic user interface (GUI) or a command line interface (CLI) or may be stored as a file.

The OT search unit 220 receives a network resource information request from the DCON device 120 in connection with a service request issued by the transmission node 140, which is an overlay network-based service provider, searches the OT information DB 270 for network OT resources requested by the DCON device 120, and provides the results of the search to the DCON device 120. The OT search unit 220 may allow or reject a request for network OT resources, issued by the DCON device 120, based on information on the contract with the DCON device 120, the operating policies of the ISN store 110, or the policies of a network OT resource provider of the network OT resources requested by the DCON device 120.

The OT monitoring unit 230 performs monitoring on the network OT resources registered in the OT information DB 270. The OT monitoring unit 230 receives state information of the network OT resources registered in the OT information DB 270 from the core node 130, and maintains the received state information, thereby monitoring the network OT resources registered in the OT information DB 270. State information of network OT resources may include operating state information (whether activated or inactivated) of network OT resources, CPU utilization rates of network OT resources, network utilization rates of network OT resources, and user information of the core node 130. The OT monitoring unit 230 may display state information of network OT resources on a screen as a GUI or CLI or may store state information of network OT resources in the OT information DB 270 as a file.

The OT management unit 240 processes a request issued by the core node 130 for the registration of network OT resources. The OT management unit 240 may modify information on and the state of the network OT resources registered in the OT information DB 270, or may delete the corresponding network OT resource information from the OT information DB 270.

The ISN user management unit 250 manages (i.e., registers, modifies, deletes, or authorizes) information on a user who wishes to use the ISN store 110, i.e., the user of the core node 130, which is a network OT resource provider.

The function test unit 260 is configured to test the functions of network OT resources provided by the core node 130. The OT management unit 240 may determine whether network OT resources to be registered in the ISN store 110 operate normally by transmitting a simple object access protocol (SOAP)-based query message to the core node 130 via the function test unit 306. The OT management unit 240 may also transmit a SOAP-based query message to the core node 130 to measure delays in the communication with another core node, e.g., the core node 131, and the bandwidth used in the communication between the core nodes 130 and 131, and to display function the results of the determination and the results of the measurement. Function test results obtained by the function test unit 260 may be stored in the OT information DB 270.

The OT information DB 270 may store various data and programs necessary for the operation of the ISN store 110. The OT information DB 270 may store network OT resource information, network OT resource state information, function test results, and network OT resource user information such that they can be searched through.

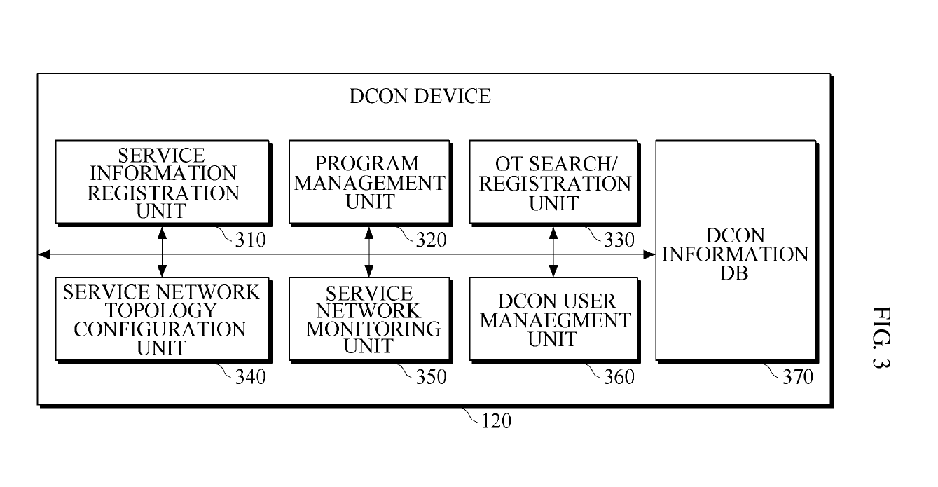

FIG. 3 illustrates an example of the DCON device 120. Referring to FIG. 3, the DCON device 120 may include a service information registration unit 310, a program management unit 320, an OT search/registration unit 330, a service network topology configuration unit 340, a service network monitoring unit 350, a DCON user management unit 360, and a DCON information DB 370. The service information registration unit 310, the program management unit 320, the OT search/registration unit 330, the service network topology configuration unit 340, the service network monitoring unit 350, the DCON user management unit 360, and the DCON information DB 370 may be interconnected via an internal network and may thus be able to transmit data to or receive data from one another.

The service information registration unit 310 may be connected to the transmission node 140, which is a service provider of overlay network-based services such as an IPTV service, an SNS, a VoIP service, or a video-on-demand (VOD) service, using an ISN-based overlay network dynamic configuration function. Thus, the transmission node 140 may be connected to the DCON device 120 via the service information registration unit 310, and may enter service information to be registered. The service information registration unit 310 registers the service information entered by the transmission node 140, and may store the registered service information in the DCON information DB 370.

The OT search/registration unit 330 receives service information input to the service information registration unit 310 by the transmission node 140. The OT search/registration unit 330 may issue a request for network OT resources (such as networking, processing, and storage resources) for transferring an overlay network-based service provided by the transmission node to the ISN store 110 and may thus acquire information on the network OT resources. The OT search/registration unit 330 may issue a request for the authorization of network OT resources for transferring an overlay network-based service to the ISN store 110. The ISN store 110 may allow or reject a request issued by the DCON device 120 based on information on the contract with the DCON device 120, the operating policies of the ISN store 110, or the policies of a network OT resource provider of the network OT resources requested by the DCON device 120.

If the use of network OT resources is authorized by the ISN store 110, the service network topology configuration unit 340 may dynamically configure an overlay network corresponding to an optimal path between the transmission node 140 and the reception node 150 based on the network OT resources. The service network topology configuration unit 340 may configure an optimal overlay network in consideration of the state of network OT resources and the specification of the reception node 150, which is a service user.

The service network topology configuration unit 340 may transmit overlay network configuration information, including an overlay network-based service transfer path, internal parameter configuration setting information, and etc. For example, the service network topology configuration unit 340 may provide the core node 130, which is included in the overlay network-based service transfer path, with the address of a previous node from which the core node 130 receives service data for an overlay network-based service, the address of a subsequent node to which the core node 130 is to output the service data, and setting information for an operation to be performed by the core node 130. The service network topology configuration unit 340 may transmit the overlay network configuration information to the transmission node 140, which is a service provider, and the reception node 150, which is a service user.

If a notification of the rejection to the use of network OT resources is received from the ISN store 110, the OT search/registration unit 330 may transmit a response message indicating that an overlay network-based service cannot be provided to the transmission node 140, which is a service provider, via the service information registration unit 310 and may thus notify the transmission node 140 that an overlay network-based service cannot be provided via the DCON device 120.

The service networking monitoring unit 350 collects state information of services provided through an overlay network configured by the service network topology configuration unit 340 and state information of network OT resources, and provides the collected service state information and the collected resource state information to the transmission node 140 as a GUI, CLI or a file. The collected service state information may include a copy of video or audio data transmitted by each node, the quality of the video or audio data, service interruption/failure information, such as a disconnection of the image or audio data, and service user information. The collected resource state information may include information indicating whether network OT resources are activated, and the CPU utilization rates and network utilization rates of network OT resources.

The program management unit 320 may manage program information on services reserved or currently being provided, via the DCON device 120, by the transmission node 140. The program management unit 320 may be configured to be connected to the reception node 150. The reception node 150 may acquire program information through the program management unit 320 of the DCON device 120, and may select any desired real-time broadcast channel or VoD content based on the acquired program information. The program management unit 320 may work with the OT search/registration unit 330 or the service network topology configuration unit 340 to provide necessary support for dynamically expanding the overlay network configured by the service network topology configuration unit 340 to include the reception node 150.

For example, the program management unit 320 may transmit a service reception request issued by the reception node 150, which is a service user, to the OT search/registration unit 330. Then, the OT search/registration unit 330 may acquire network OT resource information for providing a service requested by the reception node 150 to the reception node 150 from the ISN store 110. Then, the service network topology configuration unit 340 may configure an overlay network for providing an overlay network-based service from the transmission node 140 to the reception node 150 based on the network OT resource information acquired by the OT search/registration unit 330.

The DCON user management unit 360 may manage user profile information of the transmission nodes 140 and 141, which are service providers and wish to use the DCON device 120, and of the reception nodes 150 and 151, which are service users. The user profile information may include information on the users of the transmission nodes 140 and 141, specification information of the transmission nodes 140 and 141, information on services provided by the transmission nodes 140 and 141, information on the users of the reception nodes 150 and 151, specification information of the reception nodes 150 and 151, and display capability information of the reception nodes 150 and 151. The DCON user management unit 360 may authorize or reject access to the DCON device 120, and may perform general user management, such as generating, deleting, maintaining and modifying user accounts.

The DCON information DB 370 stores and manages information maintained and managed by the DCON device 120. For example, the DCON information DB 370 may store and manage OT search/registration-related information provided by the OT search/registration unit 330, service network topology information on a service network topology configured by the service network topology configuration unit 340, network OT resource information on network OT resources used to configure the service network topology, service state information on services provided through a service network, state information on network OT resources for providing the services, and service provider information and service user information managed by the DCON user management unit 360.

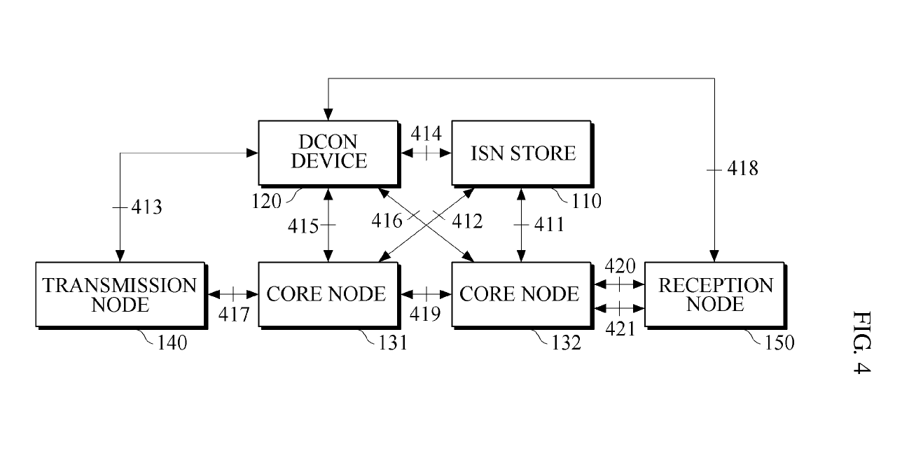

FIG. 4 illustrates examples of interfaces between the ISN store 110, the DCON device 120, the transmission node 140, the core nodes 131 and 132, and the reception node 150, which form an ISN-based overlay network. Referring to FIG. 4, network OT resources (such as networking, processing, and storage resources) provided by the core nodes 131 and 132, which correspond to network servers or transfer-related systems on the path of the transfer of overlay network-based services, are registered in the ISN store 110 via interfaces 411 and 412. The interfaces 411 and 412 may use various web service protocols such as SOAP, extensible markup language (XML), hypertext transfer protocol (HTTP), or representational state transfer (REST).

The DCON device 120 and the transmission node 140 are connected by an interface 413. The transmission node 140 may transmit overlay network-based service information to the DCON device 120 via the interface 413. A SOAP, XML, HTTP, or REST interface may be used as the interface 413.

The DCON device 120 and the ISN store 110 may be connected by an interface 414. The interface 414 may use various web service protocols such as SOAP, XML, HTTP, or REST, and network OT resource information may be transmitted from the ISN store 110 to the DCON device 120 via such web service protocol.

The DCON device 120 may be connected to the core nodes 131 and 132 by interfaces 415 and 416, respectively. The DCON device 120 may transmit various instructions and parameters for processing and transmitting overlay network service data to the core nodes 130 and 131 via the interfaces 415 and 416.

The DCON device 120 and the reception node 150 may be connected by an interface 418. The reception node 150 may receive program information provided by the DCON device 120 via the interface 418, and may acquire information on an adjacent core node (i.e., the core node 132) suitable for service reception via the interface 418.

Overlay network-based services (e.g., real-time streaming data, VoD content, or other general data) provided by the transmission node 140 may be transmitted to the core node 131 via a data transfer interface 417, and may be distributed between the core nodes 131 and 132 via an interface 419.

The reception node 150 may receive core node information specifying an adjacent core node recommended by the DCON device 120, and may access the adjacent core node specified by the received information, i.e., the core node 132, via an interface 420. The reception node 150 may receive service data such as real-time streaming data, VoD content, or other general data from the core node 132 via an interface 421.

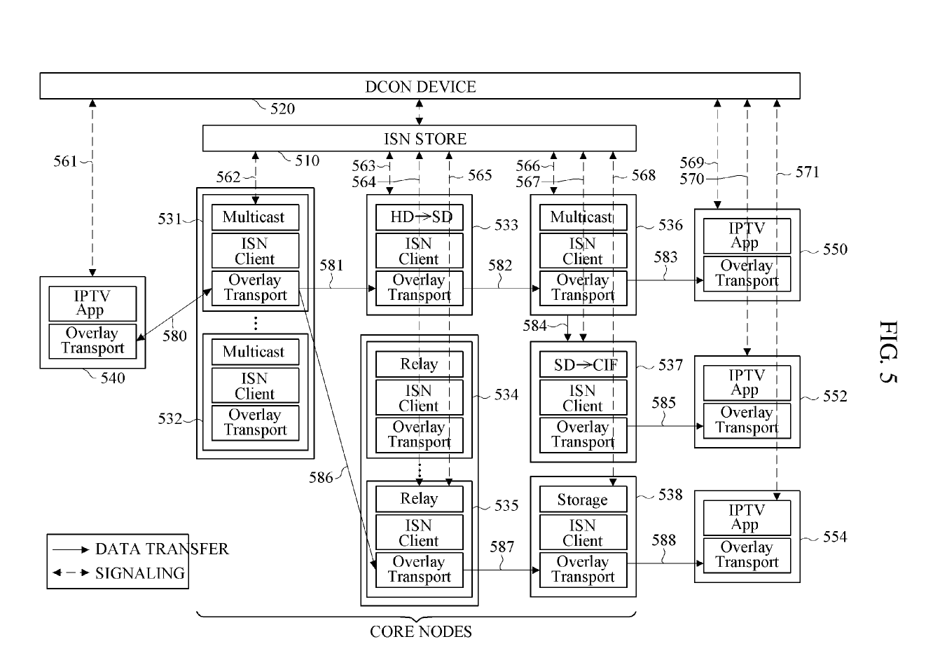

FIG. 5 illustrates an example of how to transfer network- and user-adaptive overlay multicast services through a dynamic configuration of an ISN-based overlay network using an ISN store and a DCON device. Referring to FIG. 5, an ISN store 510, a DCON device 520, network OT resource providers 531 through 538, a service provider 540, and service users 550, 552, and 554 exist in a network. The ISN store 510 corresponds to the ISN store 110 shown in FIG. 1, the DCON device 520 corresponds to the DCON device 120 shown in FIG. 1, the network OT resource providers 531 through 538 correspond to the core nodes 130 and 131 shown in FIG. 1, the service provider 540 corresponds to the transmission nodes 140 and 141 shown in FIG. 1, and the service users 550, 552, and 554 correspond to the reception nodes 150 and 151 shown in FIG. 1.

The network OT resource providers 531, 532, and 536 provide an overlay multicast function. The network OT resource provider 533 provides a high definition (HD)-to-standard definition (SD) conversion function (HD→SD). The network OT resource provider 537 provides an SD-to-central information file (CIF) conversion function (SD→CIF). The network OT resource providers 534 and 535 provide a relay function. The network OT resource provider 538 provides a storage function.

Assume that the service provider 540 is a real-time IPTV service provider, and that the service users 550, 552, and 554 are an SD fixed terminal, a CIF mobile terminal, and an HD fixed terminal, respectively.

Information on network OT resources held by the network OT resource providers 531 through 538 may be registered in the ISN store 520 through interfaces 562 through 568.

The service provider 540 transmits service information for providing a real-time IPTV service to the DCON device 520 via an interface 561. The DCON device 520 issues a request for network OT resource information for providing the real-time IPTV service to the ISN store 520 via an interface 560 based on the service information provided by the service provider 540.

The ISN store 520 receives a request issued by the DCON device 510, and transmits network OT resource information corresponding available network resources 531, 532, and 536 to the DCON device 520.

The DCON device 520 establishes an overlay network including the network OT resource provider 531 based on the network OT resources acquired from the ISN store 520 in order for the service provider 540 to provide the real-time IPTV service, and then transmits information on the established overlay network to the service provider 540 and the network OT resource provider 531. The service provider 540 can transmit HD real-time streaming data via the network OT resource provider 531 at an authorized time. Therefore, the HD real-time streaming data can be transmitted through an OT layer of the network OT resource provider 531.

The service user 550, which is an SD terminal, may access the DCON device 520, may enter user and terminal information thereof to the DCON device 520, and may then acquire program information on a desired program from the DCON device 520.

If the service user 550 selects real-time streaming data provided by the service provider 540, the DCON device 520 may set network OT resources for establishing an overlay network between the service provider 540 and the service user 550 by working with the ISN store 510 or using already available network resources. Then, the DCON device 520 may transmit the real-time streaming data selected by the service user 550 to the service user 550. In this case, the DCON device 520 may identify the media type (i.e., an HD type)of data provided by the service provider 540 and a media type (i.e., an SD type) supported by the service user 550, may expand the overlay network, if necessary, to include a network OT resource provider registered in the ISN store 110 and having an HD-to-SD conversion function, i.e., the network OT resource provider 533, and may transmit setting information to the network OT resource provider 533. As a result, a media stream provided as service data by the service provider 540 may be converted to a format that suits the service user 550 by the network OT resource provider 533, and the result of the conversion may be transmitted to the service user 550.

In order for the service user 552, which is a CIF mobile terminal, to receive a real-time stream from the service provider 540, the DCON device 520 may select a network OT resource provider registered in the ISN store 110 and having an SD-to-CIF conversion function, i.e., the network OT resource provider 537, and may transmit setting information to the network OT resource provider 537. As a result, an HD stream provided by the service provider 540 may be converted into a CID stream by the network OT resource provider 537, and the CID stream may be transmitted to the service user 552.

There may exist more than one network OT resource provider having a relay function (i.e., the network OT resource providers 543 and 535) on the path of the reception of an HD stream from the service provider 540 to the service user 554. In this case, the DCON device 520 may identify CPU and network state information of each of the network OT resource providers 534 and 535, may select one of the network OT resource providers 534 and 535, e.g., the network OT resource provider 535, as a suitable relay node for the service user 554 based on the results of the identification, and may transmit an HD stream to the service user 554 via the network OT resource provider 535.

If the service user 554 issues a request for a personal video recorder (PVR) service such as ‘pause’ to the DCON device 520 during the reception of a real-time stream, the DCON device 520 may select an available storage node registered in the ISN store 510, i.e., the network OT resource provider 538. Then, the DCON device 520 may store the real-time stream in the network OT resource provider 538 and may thus perform a pause function.

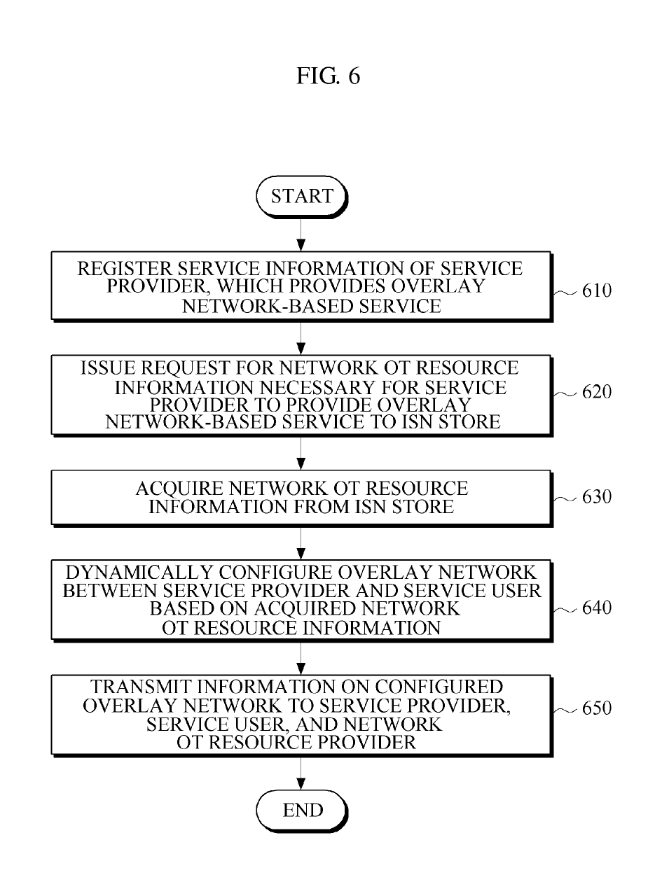

FIG. 6 illustrates a flowchart of an example of a method of dynamically configuring an overlay network, which is performed by a DCON device. Referring to FIG. 6, a DCON device registers service information provided by a service provider, which provides overlay network-based services, therein (610).

The DCON device issues a request for network OT resource information to an ISN store based on the service information provided by the service provider (620), and acquires the network OT resource information from the ISN store (630).

The DCON device dynamically configures an overlay network for providing an overlay network-based service between the service provider and a service user based on the acquired network OT resource information (640).

The DCON device transmits information on the configured overlay network to the service provider, the service user, and a network OT resource provider of network OT resources corresponding to the acquired network OT resource information (650).

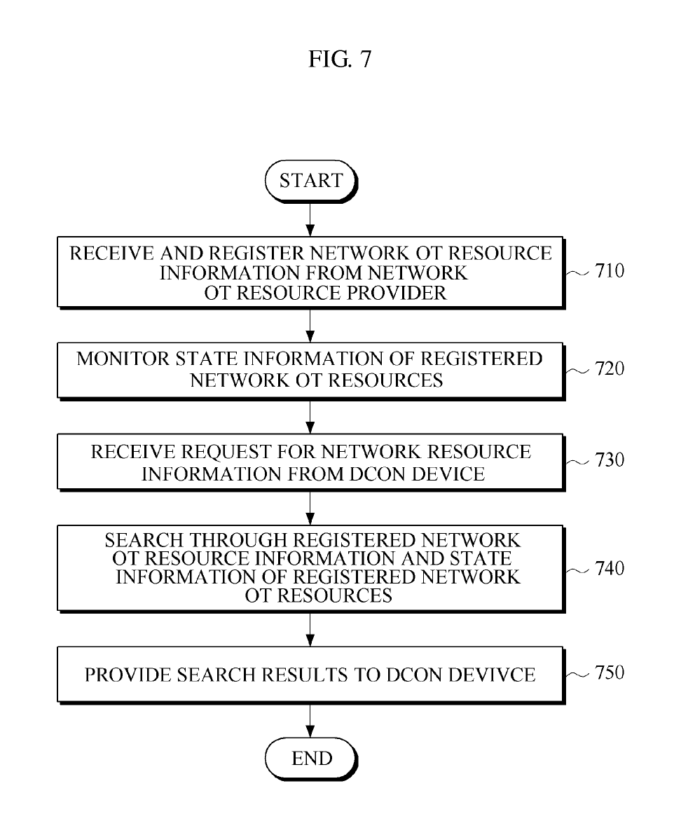

FIG. 7 illustrates a flowchart of an example of the operation of an ISN store. Referring to FIG. 7, an ISN store receives network OT resource information from a network OT resource provider (710) and registers the received information therein (720). The registered network OT resource information may be stored in an OT information DB in the ISN store.

The ISN store monitors the state of network OT resources corresponding to the registered network OT resource information (720). Network OT resource state information obtained by the monitoring may also be stored in the OT information DB.

The ISN store receives a request for network resource information, which is issued by a DCON device in response to a service user's request for an overlay network-based service (730). The ISN store searches through the registered network OT resource information and the network OT resource state information (740), and provides the results of the search to the DCON device (750).

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An apparatus for dynamically configuring an overlay network, the apparatus comprising:
a service information registration unit configured to register service information of a service provider, which provides an overlay network-based service;
an overlay transport (OT) search/registration unit configured to issue a request for network OT resource information necessary for the service provider to provide the overlay network-based service to an intelligent service network (ISN) store based on the service information, to acquire the network OT resource information from the ISN store, and to register the acquired network OT resource information; and
a service network topology configuration unit configured to dynamically configure an overlay network for providing the overlay network-based service between the service provider and a service user of the overlay network-based service based on the acquired network OT resource information and to provide information on the configured overlay network to the service provider, the service user, and a network OT resource provider of network OT resources included in the configured overlay network.

2. The apparatus of claim 1, wherein the service network topology configuration unit configures the overlay network in consideration of the states of the network OT resources and the specification of the service user.

3. The apparatus of claim 1, further comprising a program management unit configured to manage program information on a plurality of programs provided by the service provider and to provide the program information to the service user.

4. The apparatus of claim 3, wherein the program management unit transmits a request for a program service, issued by the service user, to the OT search/registration unit, the OT search/registration unit acquires network OT resource information for providing the program service from the ISN store, and the service network topology configuration unit configures an overlay network for providing the program service between the service provider and the service user based on the acquired network OT resource information.

5. The apparatus of claim 1, wherein, if a notification of rejection to the request issued by the OT search/registration unit is received from the ISN store, the OT search/registration unit transmits a response message indicating that an overlay network-based service cannot be provided to the service provider via the service information registration unit.

6. The apparatus of claim 1, further comprising a service network monitoring unit configured to monitor state information of network OT resources provided by at least one network OT resource provider in the overlay network and state information of services currently being provided through the overlay network.

7. The apparatus of claim 6, wherein the network OT resource state information includes information indicating whether network OT resources are activated, and CPU utilization rates and network utilization rates of network OT resources.

8. The apparatus of claim 7, wherein the service network monitoring unit provides the network OT resource state information to the service provider.

9. The apparatus of claim 1, further comprising a dynamic configuration-of-overlay network (DCON) user management unit configured to manage information on the service provider and information on the service user.

10. The apparatus of claim 1, further comprising a DCON information database (DB) configured to store therein the network OT resource information, state information on network OT resources used to configure the overlay network, information on the service provider, and information on the service user.

11. An ISN store comprising:
an OT registration unit configured to receive network OT resource information for providing an overlay network-based service from a network OT resource provider and register the network OT resource information;
an OT information DB configured to store the registered network OT resource information;
an OT monitoring unit configured to monitor state information of network OT resources corresponding to the registered network OT resource information; and
an OT search unit configured to receive a request for network OT resource information, which is issued in connection with a service request received by a service provider, from a DCON device, to search through the registered network OT resource information and the state information of the network resources corresponding to the registered network OT resource information, and to provide the results of the searching to the DCON device.

12. The ISN store of claim 11, further comprising an OT management unit configured to manage the registered network OT resource information in the OT information DB.

13. The ISN store of claim 11, further comprising a function test unit configured to test functions of the network resources corresponding to the registered network OT resource information and store the results of the testing in the OT information DB.

14. The ISN store of claim 11, further comprising an ISN user management unit configured to manage user information of a network OT resource provider whose network OT resource information is registered in the ISN store.

15. A method of dynamically configuring an overlay network, the method comprising:
registering service information of a service provider, which provides an overlay network-based service;
issuing a request for network OT resource information necessary for the service provider to provide the overlay network-based service to an ISN store based on the service information, and acquiring the network OT resource information from the ISN store;
dynamically configuring an overlay network for providing the overlay network-based service between the service provider and a service user of the overlay network-based service based on the acquired network OT resource information; and
providing information on the configured overlay network to the service provider, the service user, and a network OT resource provider of network OT resources included in the configured overlay network.

16. The method of claim 15, wherein the dynamically configuring the overlay network comprises configuring the overlay network in consideration of the states of the network OT resources and the specification of the service user.

17. A system for dynamically configuring an overlay network using an ISN store, the system comprising:
an ISN store configured to register and manage information on network OT resources for providing an overlay network-based service available in a network;
a DCON device configured to receive network OT resource information necessary for a service provider to provide the overlay network-based service from the ISN store upon the requests of the service provider and a service user and to dynamically configure an overlay network for providing the overlay network-based service based on the received network OT resource information; and
a network OT resource provider configured to register the network OT resources in the ISN store.

18. The system of claim 17, wherein the network OT resources provide at least one of networking, processing, and storage functions.

19. A method of dynamically configuring an overlay network, the method comprising:
allowing an ISN store to register information on network OT resources for providing an overlay network-based service available in a network;
allowing the ISN store to manage state information of the network OT resources;
allowing a DCON device to receive a request for the provision of an overlay network from a service provider, which provides an overlay network-based service;
allowing the DCON device to analyze the received request and to issue a request for necessary network OT resources to the ISN store;
allowing the ISN store to search through the network OT resource information and the network OT resource state information and to provide the results of the searching to the DCON device;
allowing the DCON device to dynamically configure an overlay network for the service provider to provide the overlay network-based service based on network OT resource information and network OT resource state information provided by the ISN store; and
allowing the DCON device to transmit information on the configured overlay network to the service provider.

20. The method of claim 19, further comprising:
allowing the DCON device to receive a request for the overlay network-based service from a service user; and
allowing the DCON device to configure the overlay network to transfer the overlay network-based service from the service provider to the service user.
